(19) United States
(12) Patent Application Publication
(10) Pub. No.: US 2026/0125157 A1
(43) Pub. Date: May 7, 2026

(54) PRE-DEPLOYED STEERABLE PARAFOIL APPARATUS FOR STRATOSPHERIC GUIDED DESCENT

(71) Applicant: Near Space Labs, Inc., Brooklyn, NY (US)

(72) Inventors: Albert Caubet, Barcelona (ES); Ignasi Lluch i Cruz, Barcelona (ES); Joan Jorquera Grau, Barcelona (ES); Jesús Domínguez Cobreros, Barcelona (ES); Conor Crowe, Barcelona (ES); Hripsime Matevosyan, Brooklyn, NY (US); Asa Jonas Ivry Block, Brooklyn, NY (US)

(21) Appl. No.: 19/368,600

(22) Filed: Oct. 24, 2025

Related U.S. Application Data
(60) Provisional application No. 63/717,513, filed on Nov. 7, 2024.

(51) Int. Cl. B64D 17/80; B64B 1/42; B64D 17/24; B64D 17/62

(52) U.S. Cl. CPC B64D 17/80; B64B 1/42; B64D 17/24; B64D 17/62

(57) ABSTRACT

A support brace for facilitating deployment of a parafoil at altitude and a related apparatus for delivering a payload to an altitude and returning the payload to Earth are provided. The support brace includes a first subsection component including (i) a connection bracket for releasably securing an inflatable balloon above the brace and (ii) an outer wall. The support brace includes a plurality of extension arms extending outwardly from the outer wall of the first subsection component, where each extension arm includes a respective distal end and angled portion, and where the angled portion of each extension arm is angled downward and away from the first subsection component. The support brace includes a parafoil support arm connecting the plurality of distal ends of the plurality of extension arms. Advantageously, the support brace ensures rapid, symmetric inflation of a parafoil and prevents tangling of the parafoil's lines.

### CROSS-REFERENCE TO RELATED APPLICATION

This application claims priority to and the benefit of U.S. Provisional Patent Application No. 63/717,513, filed on Nov. 7, 2024, which is hereby incorporated by reference herein in its entirety for all purposes.

### TECHNICAL FIELD

In general, various embodiments of this disclosure relate to a structure and assembly device for parafoil deployment and, more specifically, to a support brace that facilitates the deployment of a parafoil at high altitudes and enables guided descent of a payload to a predefined ground point.

### BACKGROUND

To date, methods for preparing and deploying a parafoil from a pre-deployed state at high altitude (e.g., stratospheric altitudes) have been met with various challenges. In some instances, parafoils are pre-folded and placed in a receptacle, such as a bag, but this approach requires following very specific folding techniques to ensure symmetric opening and to prevent tangling of the parafoil lines coupling the parafoil to a payload. These techniques are time consuming, require very specific skills, and remain error prone. Even with perfect folding, an incomplete, poor opening can result—especially at high altitudes where the air is thin (e.g., altitudes of over 20,000 feet and especially over 60,000 feet above sea level). Such an incomplete opening can prevent the parafoil from fully deploying to an inflated form, thereby reducing the parafoil's ability to control and slow the descent of a payload to which the parafoil is coupled. In some instances, pre-deployed parafoils connected to a set of semi-rigid support bars have been tried, but this approach has also resulted in significant tangling of the parafoil lines.

### SUMMARY

In various embodiments, the present disclosure relates to an improved support brace for facilitating the deployment of a parafoil at an altitude and a related apparatus for delivering a payload to an altitude and returning the payload to earth using such a support brace. In one aspect, embodiments of the invention feature a support brace for facilitating the deployment of a parafoil at an altitude. The support brace includes a first subsection component including (i) a connection bracket for releasably securing an inflatable balloon above the brace and (ii) an outer wall. The support brace includes a plurality of extension arms extending outwardly from the outer wall of the first subsection component, where each extension arm includes a respective distal end of a plurality of distal ends and a respective angled portion of a plurality of angled portions, and where the respective angled portion of each extension arm is angled downward and away from the first subsection component. The support brace includes a parafoil support arm connecting the plurality of distal ends of the plurality of extension arms.

One or more of the following features may be included. The first subsection component can further include an inner void defined by an inner wall of the support brace. In some variations, the connection bracket can be disposed within the inner void of the first subsection component and connected to the inner wall of the support brace by one or more brace ribbings. The outer wall, the plurality of extension arms, and the parafoil support arm can form a second subsection component defining at least two parafoil line voids. The at least two parafoil line voids can include a first parafoil line void and a second parafoil line void, where at least one of the plurality of extension arms separates the first parafoil line void and the second parafoil line void. The at least one of the plurality of extension arms can define portions of both the first parafoil line void and the second parafoil line void. The at least two parafoil line voids can include a first parafoil line void and a second parafoil line void configured to receive first and second subsets, respectively, of a set of parafoil lines. The at least two parafoil line voids can be arranged in a side-by-side configuration relative to the first subsection component. The plurality of distal ends of the plurality of extension arms can be angled downward and away from the first subsection component. Each extension arm can include a respective inner portion of a plurality of inner portions different from the respective angled portion of the extension arm, where the plurality of inner portions of the plurality of extension arms define a plane. In some variations, the plurality of distal ends are angled downward and away from the plane. The parafoil support arm can be configured to bias a parafoil downward and away from the first subsection component. A set of parafoil lines can be configured to contact the parafoil support arm when a parafoil coupled to the set of parafoil lines has a semi-deployed configuration.

In another aspect, embodiments of the invention feature a related apparatus for delivering a payload to an altitude and returning the payload to earth. The apparatus includes a parafoil deployable from a semi-deployed configuration to an inflated configuration. The apparatus includes a support brace for facilitating deployment of the parafoil at altitude. The support brace includes a first subsection component including (i) a connection bracket for releasably securing an inflatable balloon above the support brace and (ii) an outer wall. The support brace includes a plurality of extension arms extending outwardly from the outer wall of the first subsection component, where each extension arm includes a respective distal end of a plurality of distal ends and a respective angled portion of a plurality of angled portions, and where the respective angled portion of each extension arm is angled downward and away from the first subsection component. The support brace includes a parafoil support arm connecting the plurality of distal ends of the plurality of extension arms, where the parafoil is releasably connected to the parafoil support arm. The apparatus includes a payload and a set of payload support lines connecting the first subsection component of the support brace to the payload. The apparatus includes a set of parafoil lines connecting the parafoil to the payload, where the parafoil is released from the parafoil support arm when the parafoil deploys from the semi-deployed configuration toward the inflated configuration.

One or more of the following features may be included. The parafoil can remain connected to the payload by the set of parafoil lines when the parafoil deploys from the semi-deployed configuration toward the inflated configuration. The parafoil support arm can bias the parafoil downward and away from the first subsection component when the parafoil is arranged in the semi-deployed configuration. The parafoil can be positioned adjacent to the support brace when the parafoil is arranged in the semi-deployed configuration. The parafoil can be positioned above the support brace, the set of parafoil lines, the set of payload support lines, and the payload when the parafoil is arranged in the inflated configuration. The parafoil can be releasably connected to the parafoil support arm by the set of parafoil lines. The support brace can include at least two parafoil line voids that organize the set of parafoil lines.

These and other objects, along with advantages and features of the embodiments of the present invention herein disclosed, will become more apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1A is a left side perspective view of an apparatus for delivering a payload to an altitude and returning the payload to Earth, in accordance with some embodiments;

FIG. 1B is a right side perspective view of the apparatus of FIG. 1A, in accordance with some embodiments;

FIG. 1C is a rear side perspective view of the apparatus of FIG. 1A, in accordance with some embodiments;

FIG. 1D is a bottom perspective view of the apparatus of FIG. 1A during an inflation sequence, in accordance with some embodiments;

FIG. 1E is a bottom perspective view of the apparatus of FIG. 1A during an inflation sequence, in accordance with some embodiments;

FIG. 1F is a bottom perspective view of the apparatus of FIG. 1A during an inflation sequence, in accordance with some embodiments;

FIG. 2 is a side perspective schematic view of an apparatus for delivering a payload to an altitude and returning the payload to earth, in accordance with some embodiments;

FIG. 3A is a top perspective schematic view of a support brace, in accordance with some embodiments;

FIG. 3B is a top view of the support brace of FIG. 3A, in accordance with some embodiments; and

FIG. 3C is a side view of the support brace of FIG. 3A, in accordance with some embodiments.

### DETAILED DESCRIPTION

Aspects of this invention utilize a standard parafoil and a combination of a set of parafoil lines arranged in a novel manner, guided and supported by a novel brace structure that provides specific improvements including ensuring rapid, symmetric inflation of the parafoil and preventing tangling and line twisting of the parafoil lines. Further, this apparatus is optimized to operate properly at high altitudes and does not require specific skills for preparing the parafoil.

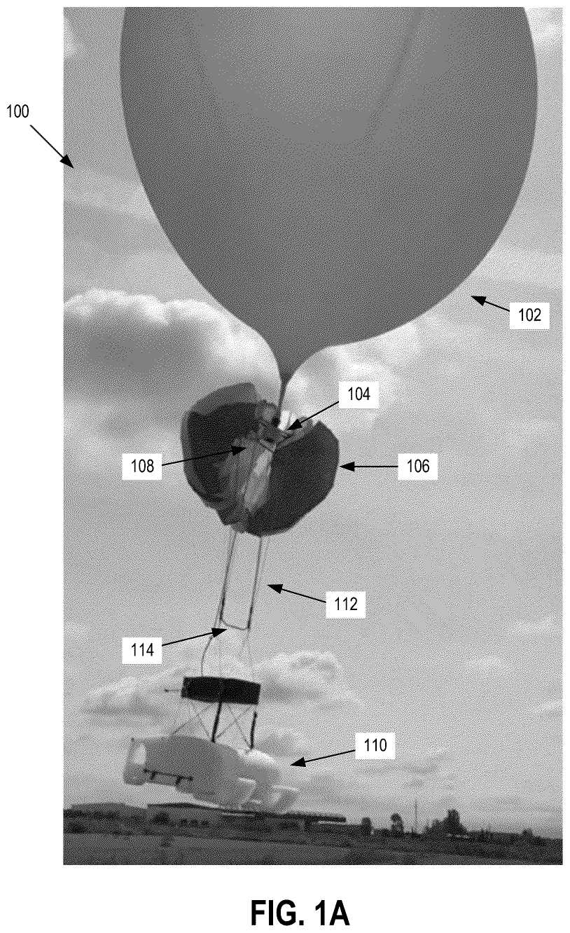

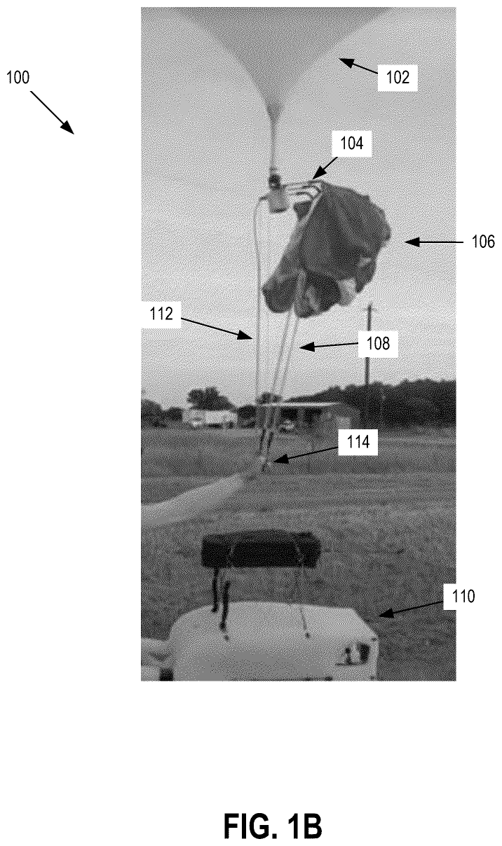

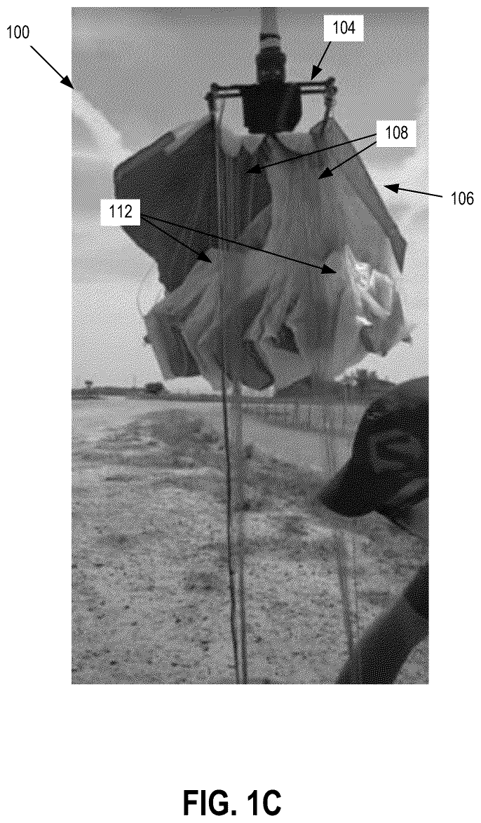

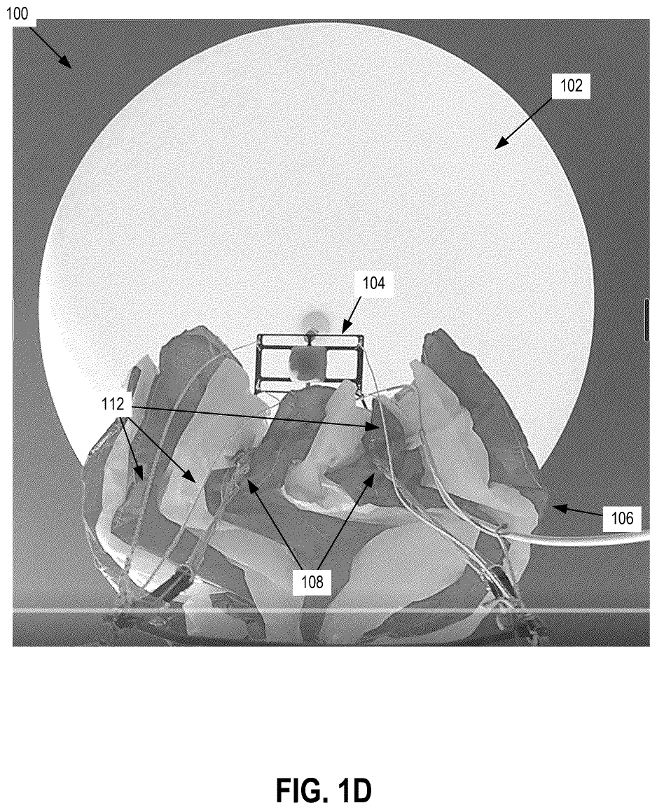

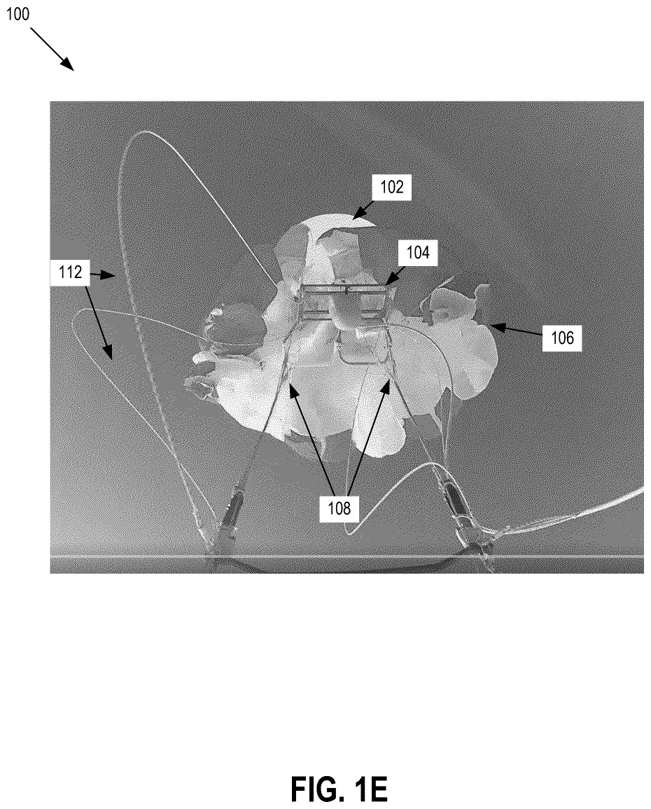

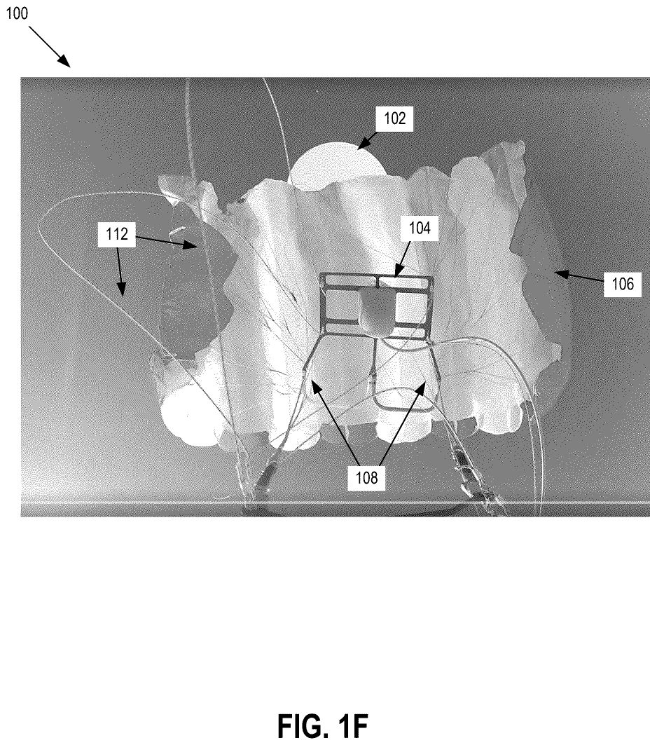

Referring to FIGS. 1A-1F, an apparatus 100 for delivering a payload to an altitude and returning the payload to Earth is shown. In some variations, the apparatus 100 can include a balloon 102, a support brace 104, a parafoil 106, a set of parafoil lines 108 for the parafoil 106, a payload 110, a set of payload support lines 112 for the payload 110, and/or a support bar 114.

In some embodiments, the apparatus can include a balloon 102 configured to lift and cause the apparatus 100 to ascend to a particular altitude. As an example, the balloon 102 may be configured to lift the apparatus 100 from ground altitude (e.g., sea level) to an altitude in a range from approximately 15,000 feet (e.g., approximately 4,500 meters) to approximately 85,000 feet (e.g., approximately 26,000 meters) above sea level, preferably to an altitude in a range from approximately 20,000 feet (e.g., approximately 6,000 meters) to approximately 60,000 feet (e.g., approximately 18,000 meters) above sea level. The balloon 102 may be positioned above each of the other components of the apparatus 100. As an example, the balloon 102 may be positioned above the support brace 104, the parafoil 106, the parafoil lines 108, the payload 110, the payload support lines 112, and the support bar 114. In some cases, the apparatus may include more than one balloon 102. The balloon 102 can be inflated with a gas, such as Helium (He), to lift the payload 110 and cause the apparatus 100 to ascend to a particular altitude. In some variations, a valve apparatus included in the support brace 104 can control the altitude of the apparatus 100 by removing (e.g., venting) gas from the inflated balloon 102. While the apparatus 100 is described herein as including a balloon 102 to provide the lift needed to cause the apparatus 100 to ascend to a particular altitude, any suitable lifting mechanism may be used in addition or alternative to the balloon 102. In some variations, the balloon 102 can be released from the apparatus 100. As an example, the balloon 102 can be released from the apparatus 100 after the apparatus 100 has reached a desired altitude and/or performed the desired tasks (e.g., collected air samples, taken images, etc.).

In some embodiments, referring to FIGS. 1A-1B, the apparatus 100 can include the support brace 104 positioned between the balloon 102 and the payload 110. The support brace 104 can be configured to facilitate deployment of the parafoil 106 at a particular altitude. The support brace 104 can be coupled to the balloon 102 and the parafoil 106, with the support brace 104 coupling the balloon 102 to the parafoil 106. In some variations, the support brace 104 can include a connection bracket by which the balloon 102 is releasably coupled to the support brace 104. The connection bracket can include a quick release and swivel mechanism configured to swivel and rotate about a central axis to allow the balloon 102 to rotate relative to the payload 110. The quick release and swivel mechanism can releasably secure the balloon 102 above the support brace 104. In some variations, the connection bracket may be controllable to selectively release the balloon 102 from the support brace 104 and the apparatus 100. In some variations, the support brace 104 can include a valve system for altitude control of the apparatus 100 as described herein. As an example, the connection bracket may include the valve system for altitude control of the apparatus 100.

In some embodiments, the apparatus 100 can include a parafoil 106 coupled to a support bar 114 (also referred to as a “risers bar 114”). The parafoil 106 can be configured to control and guide the descent of the apparatus 100. As an example, the parafoil 106 can be steerable to control and guide the descent of the apparatus 100 from a particular altitude upon release of the balloon 102 from the apparatus 100, thereby slowing the descent of the apparatus 100 to a predefined ground point. The parafoil 106 may be deployable from a semi-deployed configuration (also referred to as a “semi-unfolded configuration” and “pre-deployed configuration”) to an inflated configuration (also referred to as a “fully-deployed configuration”). Referring to FIGS. 1A-1C, the parafoil 106 can be positioned in a semi-deployed configuration. Upon deployment, the parafoil 106 can be positioned in an inflated configuration. The parafoil 106 may move from the semi-deployed configuration to the inflated configuration when the parafoil 106 deploys by catching and collecting air (e.g., due to air drag against the surface of the parafoil 106), thereby causing the parafoil 106 to inflate and expand from the semi-deployed configuration toward the inflated configuration.

In some embodiments, the apparatus 100 can include a set of parafoil lines 108 (also referred to as “parafoil support lines 108”) for the parafoil 106. The set of parafoil lines 108 can support the parafoil 106 and couple the parafoil 106 to the payload 110. The set of parafoil lines 108 can be configured to allow for deployment of the parafoil 106 from the semi-deployed configuration to the inflated configuration. When the parafoil 106 has the semi-deployed configuration, one or more of the set of parafoil lines 108 may be loose, such that slack exists in one or more of the parafoil lines 108 between the parafoil 106 and the payload 110. When the parafoil 106 has the inflated configuration, each parafoil line of the set of parafoil lines 108 may be under tension (e.g., taut), such that little or no slack exists in each of the parafoil lines 108 between the parafoil 106 and the payload 110, and the parafoil lines 108 are under tension from the forces of the parafoil 106 and the payload 110. In some variations, the parafoil lines 108 can extend through one or more voids (e.g., parafoil line voids) formed by a subsection component (e.g., second subsection component) of the support brace 104 as described herein.

In some embodiments, the apparatus 100 can include a payload 110. In some variations, the payload 110 can be and/or include a payload flight vehicle. The payload 110 may be positioned below each of the other components of the apparatus 100 during the ascent of the apparatus 100. As an example, the payload 110 may be positioned below the balloon 102, the support brace 104, the parafoil 106, the parafoil lines 108, the payload support lines 112, and/or the support bar 114. The payload 110 may be configured to perform one or more tasks. As an example, the payload 110 may be configured to perform tasks such as collecting air samples and/or taking images while the apparatus 100 ascends to a particular altitude, remains at a particular altitude, and/or descends from a particular altitude. The payload 110 may be connected to one or more (e.g., each) of the parafoil lines 108, such that the parafoil 106 provides guided descent of the payload 110. In some variations, the payload 110 may be coupled to the parafoil lines 108 via a support bar 114, with the support bar 114 positioned between the parafoil lines 108 and the payload 110. In some variations, the payload 110 may be directly coupled to the parafoil lines 108.

In some embodiments, the apparatus 100 can include a set of payload support lines 112 for the payload 110. The set of payload support lines 112 can support the payload 110 and couple the support brace 104 (e.g., the first subsection component of the support brace 104) to the payload 110. As an example, the first subsection component of the support brace 104 can include a number of holes by which the payload support lines 112 are coupled (e.g., attached) to the support brace 104, with the payload support lines 112 supporting (e.g., carrying) and serving as the primary load-bearing lines for the payload 110 positioned below the support brace 104. When the apparatus 100 ascends to a particular altitude and/or hovers at a particular altitude, the set of payload support lines 112 may be under tension (e.g., taut), such that little or no slack exists in each of the payload support lines 112 between the support brace 104 and the payload 110, and the payload support lines 112 are under tension from the force (e.g., weight) of the payload 110. In some variations, the payload 110 may be coupled to the payload support lines 112 via the support bar 114, with the support bar 114 positioned between the payload support lines 112 and the payload 110. In some variations, the payload 110 may be directly coupled to the payload support lines 112.

In some embodiments, the apparatus 100 can include a support bar 114. The support bar 114 can be coupled to each of the parafoil lines 108, payload 110, and payload support lines 112, with the payload 110 positioned on a first side of the support bar 114 and both the parafoil lines 108 and payload support lines 112 positioned on a second side of the support bar 114 opposite the first side. The support bar 114 can define an axis and/or point at which ends of both the parafoil lines 108 and payload support lines 112 are coupled. As an example, ends of both the parafoil lines 108 and the payload support lines 112 directly coupled to the support bar 114 can converge at a single axis and/or point defined by the support bar 114 above the payload 110 and below the parafoil 106. In some cases, the support bar 114 can include a first end and a second end opposite the first end, with first ends of both the parafoil lines 108 and the payload support lines 112 directly attached to the first end of the support bar 114 and second ends of both the parafoil lines 108 and the payload support lines 112 that are different from the first ends directly attached to the second end of the support bar 114.

Importantly, referring to FIGS. 1A-1C, the parafoil 106 is not folded into a bag or other receptacle and is instead pre-deployed in a semi-deployed configuration. Further, rather than the parafoil 106 being supported by a system of semi-rigid bars embedded in the parafoil 106 itself with the payload 110 hanging from the parafoil lines 108, the support brace 104 is provided such that the ascension balloon 102 is attached to the top of the support brace 104 and supports both the payload 110 and the parafoil 106. The parafoil lines 108 can be extended but may be not under tension while the apparatus 100 ascends to a particular altitude via the balloon 102. When the parafoil 106 has the semi-deployed configuration, the parafoil 106 is not extended and inflated, but rather is positioned in a mushroom shape adjacent to the support brace 104, with the parafoil lines 108 extended and arranged next to each other from the support bar 114, through voids defined by the support brace 104, and to the parafoil 106. In some variations, the support brace 104 maintains the parafoil 106 in the semi-deployed configuration, with the parafoil lines 108 organized (e.g., straight and groomed without tangling) while the apparatus 100 ascends. Further, the support brace 104 hangs from the balloon 102 while supporting the weight of the payload 110.

Referring to FIGS. 1B and 1C, the parafoil 106 is shown in a semi-deployed configuration hanging off of (e.g., suspended from) an angled parafoil support arm of the support brace 104 and away from both the parafoil lines 108 and payload support lines 112. Thus, via the configuration of the parafoil support arm of the support brace 104 and the arrangement of the parafoil 106 and parafoil lines 108 thereon, the parafoil 106 is arranged to avoid entanglement between the parafoil 106, the parafoil lines 108, and the payload support lines 112 during deployment of the parafoil 106 from the semi-deployed configuration to the inflated configuration. Further, when the parafoil 106 is arranged in the semi-deployed configuration and hung off of the support brace 104, the parafoil lines 108 contact and rest against the parafoil support arm of the support brace 104 within the void(s) defined by the support brace 104, thereby releasably connecting the parafoil 106 with the support brace 104.

In some embodiments, the balloon 102 can be inflated and the apparatus 100 can be released from a position (e.g., on the ground) to ascend to a particular altitude. After the apparatus 100 has reached the desired altitude and/or performed the desired tasks (e.g., collected air samples, taken images, etc.), the balloon 102 can be released from the support brace 104 via the connection bracket. As shown in FIG. 1D and when the balloon 102 is released as part of an inflation sequence for the parafoil 106, tension on the payload support lines 112 holding the payload 110 can loosen due to the lack of an upward force (e.g., previously applied by the balloon 102) acting on the payload support lines 112, such that the apparatus 100 begins a free fall from altitude toward the ground. As shown in FIGS. 1E and 1F, as part of the inflation sequence for the parafoil 106, when the apparatus 100 falls toward the ground, the parafoil 106, having the semi-deployed configuration, catches wind (e.g., via air drag) and tends to remain positioned upward relative to the payload 110 and the support brace 104, while the support brace 104 that was previously supporting the balloon 102 and parafoil 106 moves (e.g., slides) downward around the parafoil lines 108. As the support brace 104 moves downward, the parafoil lines 108 move through the voids (e.g., parafoil line voids) defined by the support brace 104 and/or expand from their organized arrangement along the parafoil support arm of the support brace 104 as the parafoil 106 is deployed and inflates to the inflated configuration.

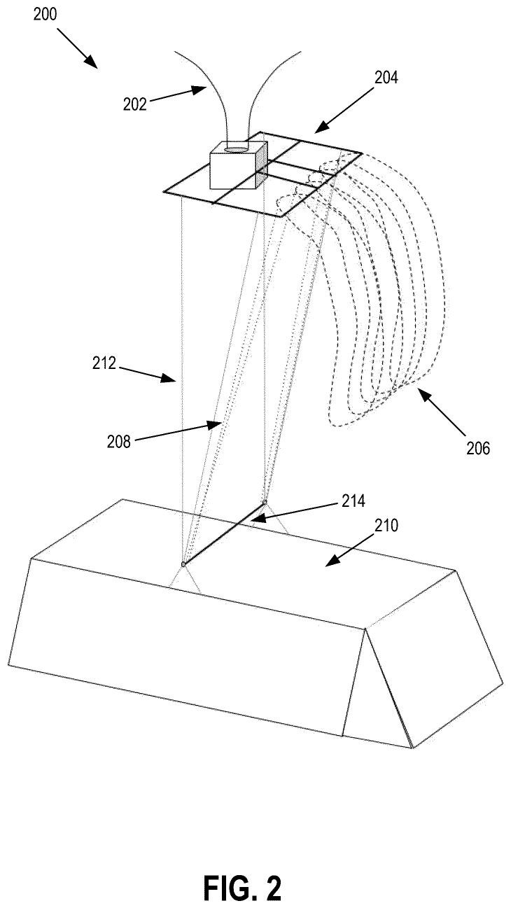

Referring to FIG. 2, a side schematic perspective view of an apparatus 200 for delivering a payload to an altitude and returning the payload to Earth is shown. In some variations, the apparatus 200 can include a balloon 202, a support brace 204, a parafoil 206, a set of parafoil lines 208 for the parafoil 206, a payload 210, a set of payload support lines 212 for the payload 210, and/or a support bar 214. The apparatus 200 can include one or more (e.g., all) of the features of an apparatus (e.g., apparatus 100) for delivering a payload to an altitude and returning the payload to Earth as described herein.

In some embodiments, referring to FIG. 2, each of the payload support lines 212 that join the support brace 204 with the payload 210 (e.g., along the same axis defined by the support bar 214 where the parafoil lines 208 are attached) may be configured to be shorter than the shortest parafoil line 208 coupled to the parafoil 206 (e.g., including or excluding the length of the support bar 214). As an example, the payload support lines 212 that join the support brace 204 with the payload 210 may be configured to be in a range of 0 percent (%) to 50% shorter (e.g., preferably 10% to 40% shorter) than the shortest parafoil line 208 coupled to the parafoil 206. When the parafoil 206 is positioned in the semi-deployed configuration and before deployment, the parafoil 206 can be hung towards the “front” or travel direction of the payload 210 as shown in FIG. 2. After deployment of the parafoil 206 from the semi-deployed configuration to the inflated configuration, the parafoil 206 can provide guided descent of the apparatus 200 and be positioned above each of the support brace 204, the parafoil 206, the set of parafoil lines 208 for the parafoil 206, the payload 210, the set of payload support lines 212 for the payload 210, and/or the support bar 214 during the descent of the apparatus from altitude to a (e.g., predefined) ground point.

In some embodiments, one or more of the parafoil lines 208 can have the same lengths or different lengths and one or more of the payload support lines 212 can have the same lengths or different lengths. In some variations, each of the payload support lines 212 may be shorter (e.g., at least 10% shorter) than the length of the parafoil lines 208. In some variations, the support bar 214 can have a length that is in a range of 10% to 20% (e.g., preferably 15%) of the length of one of the parafoil lines 208. In some variations, lengths of the parafoil lines 208, the payload support lines 212, and the support bar 214 and the relative positioning thereof can be selected based on desired flight dynamics of the apparatus 200.

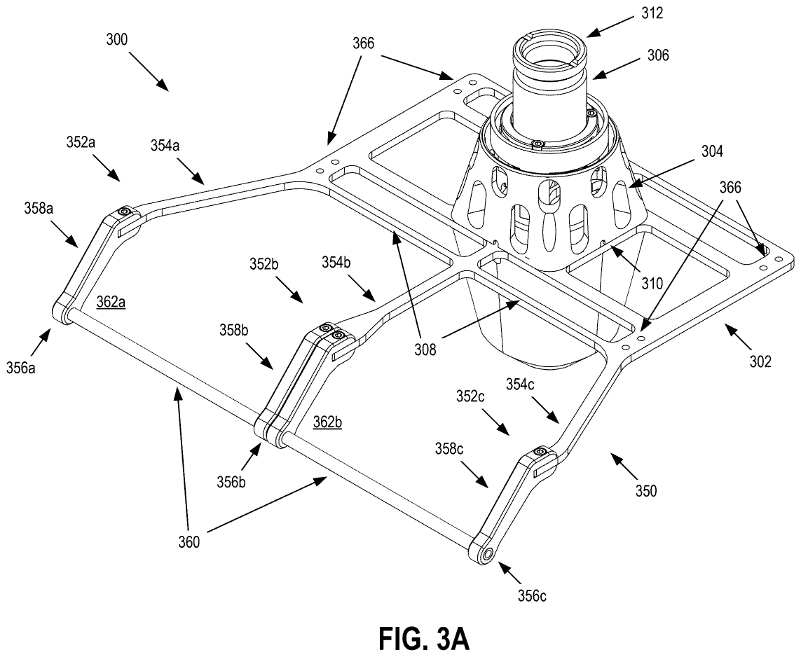

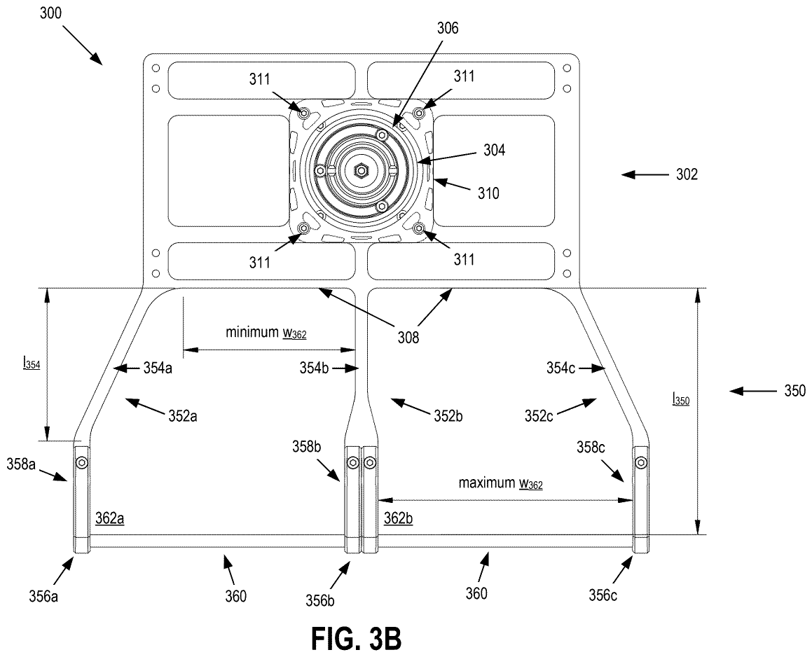

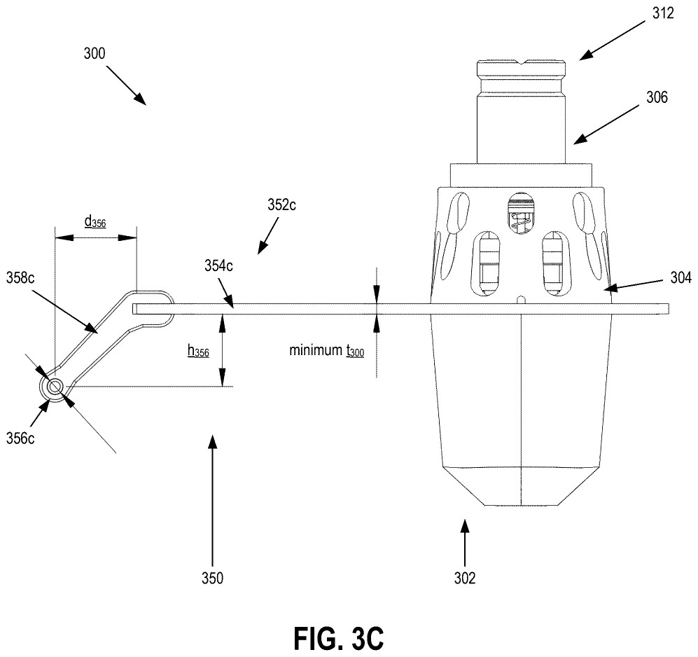

Referring to FIGS. 3A-3C, an exemplary support brace 300 for facilitating the deployment of a parafoil at altitude is shown. Embodiments of such a support brace 300 are usable as a support brace within an apparatus (e.g., apparatus 100 and/or apparatus 200) as described herein. In some variations, the support brace 300 can be made from and/or include a carbon fiber material. The support brace can include a first subsection component 302 and a second subsection component 350. The first subsection component 302 can include a connection bracket 304 by which a balloon can be releasably coupled to the support brace 300. The connection bracket 304 can include a quick release and swivel mechanism 306 configured to (i) swivel and rotate about a central axis to allow the balloon to rotate relative to the support brace 300 and (ii) enable selective release of the balloon from the support brace 300. The quick release and swivel mechanism 306 can releasably secure the balloon above the support brace 300. In some variations, the quick release and swivel mechanism 306 can include a disposable insert 312 that is configured to be inserted into the balloon and allow for the rotation of the balloon about the central axis. The connection bracket 304 may be controllable to selectively release the balloon from the support brace 300. As an example, the connection bracket 304 may be controllable to selectively release the balloon and/or the disposable insert 312 from the connection bracket 304 and the support brace 300.

In some variations, the support brace 300 can include a valve system for altitude control of the support brace 300 and an apparatus including the support brace 300 (e.g., the apparatus for delivering a payload to an altitude) as described herein. The valve system may be included within the connection bracket 304. The valve system may be controllable to enable selective release (e.g., venting) of gas from a balloon coupled to the connection bracket 304, thereby allowing for altitude control of the support brace 300 and an apparatus including the support brace 300. In some variations, the valve system may include a valve and one or more actuators (e.g., motors) configured to actuate the valve to release gas from the balloon.

In some embodiments, the first subsection component 302 can include an inner void (not shown) defined by an inner wall 310 of the support brace 300. The inner void may exist in the first subsection component 302 in the area within which the connection bracket 304 is positioned as shown in FIGS. 3A-3C. The connection bracket 304 may be disposed within the inner void of the first subsection component 302 and connected to the inner wall 310 of the support brace 300 by one or more brace ribbings 311 (e.g., fasteners such as screws). As shown in the example of FIG. 3B, the connection bracket 304 may be disposed within the inner void of the first subsection component 302 and connected to the inner wall 310 of the support brace 300 by a set of four brace ribbings at the corners of the connection bracket 304.

In some embodiments, the first subsection component 302 of the support brace 300 can include an outer wall 308. The support brace 300 can include one or more extension arms 352 extending outwardly from the outer wall 308 of the first subsection component 302. In some variations, as shown in FIGS. 3A and 3B, the support brace 300 can include a number of extension arms 352. In the example of FIGS. 3A-3C, the support brace 300 can include a first extension arm 352a, a second extension arm 352b, and a third extension arm 352c. In some variations, each of the extension arms 352 may define a plane, with each of the extension arms 352 extending along the same plane. In some variations, each extension arm 352 can include an inner portion 354 directly connected to and extending from the outer wall 308. As an example, inner portions 354 of each of the extension arms 352 directly connected to and extending from the outer wall 308 may form a plane, with each of such inner portions 354 extending along the same plane as shown in FIGS. 3A and 3C. In the example of FIG. 3A, the first extension arm 352a can include a first inner portion 354a, the second extension arm 352b can include a second inner portion 354b, and the third extension arm 352c can include a third inner portion 354c. In some variations, each extension arm 352 can include a distal end 356. In the example of FIG. 3A, the first extension arm 352a can include a first distal end 356a, the second extension arm 352b can include a second distal end 356b, and the third extension arm 352c can include a third distal end 356c. In some variations, the distal ends 356 of the extension arms 352 can be angled downward and away from the plane defined by inner portions 354 of the extension arms 352.

In some variations, the support brace 300 can include a parafoil support arm 360. The parafoil support arm 360 and/or a portion thereof can connect each of the distal ends 356 of the extension arms 352. As shown in the example of FIG. 3B, a first portion of the parafoil support arm 360 can connect the distal ends 356a, 356b of the extension arms 352a, 352b, respectively, and a second portion of the parafoil support arm 360 can connect the distal ends 356b, 356c of the extension arms 352b, 352c, respectively. Each extension arm 352 can include an angled portion 358 that is angled downward and away from both the first subsection component 302 and the inner portions 354 of the extension arms 352. In the example of FIG. 3A, the first extension arm 352a can include a first angled portion 358a, the second extension arm 352b can include a second angled portion 358b, and the third extension arm 352c can include a third angled portion 358c. In some variations, the angled portions 358 of the extension arms 352 can include the distal ends 356, with each angled portion 358 of an extension arm 352 including a distal end 356. Based on the angling of the angled portions 358 of the extension arms 352, the distal ends 356 of the extension arms 352 can be angled downward and away from the first subsection component 302 and the inner portions 354 of the extension arms 352.

In some embodiments, the outer wall 308, the extension arms 352, and the parafoil support arm 360 can form the second subsection component 350, with the second subsection component 350 defining one or more (e.g., two or more) parafoil line voids 362. In the example of FIG. 3A, the second subsection component 350 can define a first parafoil line void 362a and a second parafoil line void 362b, with the extension arm 352b separating the first parafoil line void 362a and the second parafoil line void 362b. Each of the parafoil line voids 362 can have the same or a different geometry. In some variations, one or more of the parafoil line voids 362 can have a geometric shape, such as a quadrilateral (e.g., square shape). In some variations, referring to FIGS. 3A-3C, the parafoil line voids 362 can be arranged in a side-by-side configuration relative to the first subsection component 302 of the support brace 300. As an example, the parafoil line voids 362 can be arranged in a side-by-side configuration relative to the connection bracket of the first subsection component 302.

In some embodiments, at least one of the extension arms 352 can define portions of two adjacent (e.g., side-by-side) parafoil line voids 362. As an example, the extension arm 352b can define portions of both the first parafoil line void 362a and the second parafoil line void 362b. A number of parafoil line voids 362 defined by the second subsection component may be based on (e.g., defined by) a number of extension arms 352 included in the support brace 300. As an example, the support brace 300 may include a number of parafoil line voids 362 equivalent to one less than the number of extension arms 352 included in the support brace 300. Each of the parafoil line voids 362 may be configured to receive at least some of the parafoil lines coupled to a parafoil. In some variations, each of the parafoil line voids 362 may be configured to receive a distinct subset of the parafoil lines coupled to the parafoil, with each of the parafoil lines extending through a respective one of the parafoil line voids 362. As an example, the first parafoil line void 362a may receive a first half of the parafoil lines connected to the parafoil and the second parafoil line void 362b may receive the other, second half of the parafoil lines connected to the parafoil.

In some embodiments, the first subsection component 302 of the support brace 300 can include a number of openings 366 (e.g., holes) by which payload support lines are coupled (e.g., attached) to the support brace 300. In the example of FIGS. 3A-3C, the first subsection component 302 can include openings 366 on its corners.

In some embodiments, the parafoil support arm 360 can be angled downward and away from the first subsection component 302. Such a configuration of the parafoil support arm 360 enables the parafoil support arm 360 to bias a parafoil downward and away from the first subsection component 302 (e.g., when the parafoil has the semi-deployed configuration), thereby preventing entanglement between the parafoil, its parafoil lines, and payload support lines for a payload during deployment of the parafoil from the semi-deployed configuration to the inflated configuration. Further, the parafoil lines arranged to extend through the parafoil line voids 362 and connected to the parafoil are configured to contact (e.g., rest against) the parafoil support arm 360 when a parafoil coupled to the parafoil lines has a semi-deployed configuration. By separation and organization of the parafoil lines within the parafoil line voids 362 and/or on the parafoil support arm 360, the parafoil lines are restrained to promote smooth deployment and prevent entanglement with a parafoil and payload support lines during deployment of the parafoil from the semi-deployed configuration to the inflated configuration. Further, the combination of the parafoil support arm 360 and the parafoil line voids 362 maintains the parafoil in the semi-deployed configuration, with the parafoil lines organized (e.g., straight and groomed without tangling) while an apparatus including the support brace 300 ascends to an altitude and/or remains at an altitude.

In some embodiments, the support brace 300 may be shaped or sized according to the payload being supported by the support brace 300. In the example of FIGS. 3A-3C, the support brace 300 and/or portions thereof can have dimensions as described herein. The second subsection component 350 can have a length l₃₅₀ in a range of 100 mm to 140 mm, e.g., preferably 120 mm. One or more of the inner portions of the extension arms 352 can have a length l₃₅₄ in a range of 50 mm to 100 mm, e.g., preferably 74.46 mm. One or more of the parafoil line voids 362 can have a minimum width w₃₆₂ in a range of 60 mm to 100 mm, e.g., preferably 83.63 mm, with the minimum width w₃₆₂ being, for example, the width between different inner portions 354. One or more of the parafoil line voids 362 can have a maximum width w₃₆₂ in a range of 100 mm to 150 mm, e.g., preferably 123.9 mm, with the maximum width w₃₆₂ being, for example, the width between different angled portions 358. The support brace 300 or a portion thereof (e.g., inner portions 354) can have a minimum thickness t₃₀₀ in a range of 1 mm to 10 mm, e.g., preferably 4 mm. As shown in FIG. 3C, one or more of the distal ends 356 of the extension arms 352 can be positioned at a height h₃₅₆ in a range of 20 mm to 40 mm, e.g., preferably 28 mm, below at least one (e.g., each) of the inner portions 354. As shown in FIG. 3C, one or more of the distal ends 356 of the extension arms 352 can be positioned at a distance d₃₅₆ in a range of 20 mm to 40 mm, e.g., preferably 31.5 mm, beyond an end of a length of at least one (e.g., each) of the inner portions 354. As shown in FIG. 3C, one or more of the angled portions 358 of the extension arms 352 can have a length in a range of 28 mm to 57 mm, e.g., preferably 42.15 mm. Various embodiments include any parameter value (e.g., decimal value) within the cited ranges. Express support and written description of these values for each parameter are hereby represented.

Preferred embodiments of the support brace 300 can have dimensions proportional to a size of the parafoil with which the support brace 300 is used. In the example of FIGS. 3A-3C, the support brace 300 is sized to support a parafoil that has a width of 2.7 meters and a length of 1 meter.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A support brace for facilitating deployment of a parafoil at altitude, the brace comprising:
a first subsection component comprising (i) a connection bracket for releasably securing an inflatable balloon above the brace and (ii) an outer wall;
a plurality of extension arms extending outwardly from the outer wall of the first subsection component, wherein each extension arm comprises a respective distal end of a plurality of distal ends and a respective angled portion of a plurality of angled portions, and wherein the respective angled portion of each extension arm is angled downward and away from the first subsection component; and
a parafoil support arm connecting the plurality of distal ends of the plurality of extension arms.

2. The support brace of claim 1, wherein the first subsection component further comprises an inner void defined by an inner wall of the support brace.

3. The support brace of claim 2, wherein the connection bracket is disposed within the inner void of the first subsection component and connected to the inner wall of the support brace by one or more brace ribbings.

4. The support brace of claim 1, wherein the outer wall, the plurality of extension arms, and the parafoil support arm form a second subsection component defining at least two parafoil line voids.

5. The support brace of claim 4, wherein the at least two parafoil line voids comprise a first parafoil line void and a second parafoil line void, and wherein at least one of the plurality of extension arms separates the first parafoil line void and the second parafoil line void.

6. The support brace of claim 5, wherein the at least one of the plurality of extension arms defines portions of both the first parafoil line void and the second parafoil line void.

7. The support brace of claim 4, wherein the at least two parafoil line voids comprise a first parafoil line void and a second parafoil line void configured to receive first and second subsets, respectively, of a set of parafoil lines.

8. The support brace of claim 4, wherein the at least two parafoil line voids are arranged in a side-by-side configuration relative to the first subsection component.

9. The support brace of claim 1, wherein the plurality of distal ends of the plurality of extension arms are angled downward and away from the first subsection component.

10. The support brace of claim 1, wherein each extension arm comprises a respective inner portion of a plurality of inner portions different from the respective angled portion of the extension arm, and wherein the plurality of inner portions of the plurality of extension arms define a plane.

11. The support brace of claim 10, wherein the plurality of distal ends are angled downward and away from the plane.

12. The support brace of claim 1, wherein the parafoil support arm is configured to bias a parafoil downward and away from the first subsection component.

13. The support brace of claim 1, wherein a set of parafoil lines is configured to contact the parafoil support arm when a parafoil coupled to the set of parafoil lines has a semi-deployed configuration.

14. An apparatus for delivering a payload to an altitude and returning the payload to Earth, the apparatus comprising:
a parafoil deployable from a semi-deployed configuration to an inflated configuration;
a support brace for facilitating deployment of the parafoil at altitude, the support brace comprising:
a first subsection component comprising (i) a connection bracket for releasably securing an inflatable balloon above the support brace and (ii) an outer wall;
a plurality of extension arms extending outwardly from the outer wall of the first subsection component, wherein each extension arm comprises a respective distal end of a plurality of distal ends and a respective angled portion of a plurality of angled portions, and wherein the respective angled portion of each extension arm is angled downward and away from the first subsection component; and
a parafoil support arm connecting the plurality of distal ends of the plurality of extension arms, wherein the parafoil is releasably connected to the parafoil support arm;
a payload;
a set of payload support lines connecting the first subsection component of the support brace to the payload; and
a set of parafoil lines connecting the parafoil to the payload, wherein the parafoil is released from the parafoil support arm when the parafoil deploys from the semi-deployed configuration toward the inflated configuration.

15. The apparatus of claim 14, wherein the parafoil remains connected to the payload by the set of parafoil lines when the parafoil deploys from the semi-deployed configuration toward the inflated configuration.

16. The apparatus of claim 14, wherein the parafoil support arm biases the parafoil downward and away from the first subsection component when the parafoil is arranged in the semi-deployed configuration.

17. The apparatus of claim 14, wherein the parafoil is positioned adjacent to the support brace when the parafoil is arranged in the semi-deployed configuration.

18. The apparatus of claim 14, wherein the parafoil is positioned above the support brace, the set of parafoil lines, the set of payload support lines, and the payload when the parafoil is arranged in the inflated configuration.

19. The apparatus of claim 14, wherein the parafoil is releasably connected to the parafoil support arm by the set of parafoil lines.

20. The apparatus of claim 14, wherein the support brace comprises at least two parafoil line voids that organize the set of parafoil lines.
